(19) United States
(12) Patent Application Publication
(10) Pub. No.: US 2020/0286137 A1
(43) Pub. Date: Sep. 10, 2020

(54) DEVICE AND METHOD FOR DETERMINING REFUEL SAVINGS

(71) Applicant: VOLKSWAGEN AKTIENGESELLSCHAFT, Wolfsburg (DE)

(72) Inventors: Kathrin WILKENS, Wolfsburg (DE); Carsten BRAMANN, Berlin (DE); David BISCHOF, Braunschweig (DE)

(21) Appl. No.: 16/063,426

(22) PCT Filed: Dec. 1, 2016
(86) PCT No.: PCT/EP2016/079438

§ 371 Date: Jun. 18, 2018

(30) Foreign Application Priority Data
Dec. 18, 2015 (DE) 10 2015 225 964.1
Jun. 1, 2016 (DE) 10 2016 209 567.6

(51) Int. Cl. G06Q 30/02; G01C 21/34; G01C 21/36; H04W 4/44

(52) U.S. Cl. CPC G06Q 30/0283; H04W 4/44; G01C 21/3697; G01C 21/3469

(57) ABSTRACT

A method for ascertaining a refuel savings for a transportation vehicle including determining a desired quantity of fuel; determining a first fuel price of a first filling station and a second fuel price of a second filling station; determining a first additional fuel requirement produced by driving from a current location to a first position of the first filling station and a second additional fuel requirement produced by driving from the current location to a second position of the second filling station; and determining the refuel savings using the desired quantity of fuel, the first fuel price, the first additional fuel requirement, the second fuel price, and the second additional fuel requirement.

### PRIORITY CLAIM

This patent application is a U.S. National Phase of International Patent Application No. PCT/EP2016/079438, filed 1 Dec. 2016, which claims priority to German Patent Application Nos. 10 2015 225 964.1, filed 18 Dec. 2015, and 10 2016 209 567.6, filed 1 Jun. 2016, the disclosures of which are incorporated herein by reference in their entireties.

### SUMMARY

Illustrative embodiments relate to a method for ascertaining a refuel savings in a preselected currency for a transportation vehicle and a corresponding device.

### BRIEF DESCRIPTION OF THE DRAWINGS

Exemplary embodiments will be described in greater detail hereafter with reference to the appended figures. In the figures:

FIG. 1 shows a flow chart of an exemplary embodiment of a method for ascertaining a refuel savings;

FIG. 2 schematically shows a block diagram of a device for ascertaining a refuel savings for a transportation vehicle; and

FIG. 3 shows an example of a display device, on which the possible refuel savings and additional optional items of information are displayed.

### DETAILED DESCRIPTION

Programs and apps, in particular, for mobile devices, for displaying present fuel prices, for example, of gasoline, diesel and gas prices, are already widespread. They are used for the purpose of facilitating the selection of a favorable filling station or an acquisition point for fuels for a user. Fuels are all materials or resources which can be used for the purpose of driving a transportation vehicle. Fuels can thus also be electrical energy (current), hydrogen, or liquid gas, for example. In the case of electrical energy as a fuel, the fuel price can thus be, for example, a kilowatt price. Inter alia, these above-mentioned prices are to fall under the concept of a fuel price hereafter. In principle, fuel prices are specified in a specific currency of a country per quantity unit; in Europe, for example, in euros/liter or euros/kilogram or cents/liter or cents/kilogram. According to some implementations, the displayed fuel prices in the apps can be limited to a vicinity (km), a type of the fuel (for example, diesel or gasoline), and/or a specific brand of a filling station. The respective displayed result list is frequently sorted according to the present fuel price/quantity, and therefore the user receives the most favorable price per quantity unit displayed in the search selected by him or her. The user can see the respective price advantage per quantity unit of the respective fuel therefrom. However, an overall consideration of the price advantage per refueling stop/refueling procedure does not result from the displays, and therefore it is not possible for a user of conventional solutions to recognize an absolute refuel savings upon the use of a specific filling station and to make the most favorable refueling decision in consideration of all relevant parameters.

Disclosed embodiments ascertain the possible refuel savings per refueling stop or refueling procedure more accurately.

In some exemplary embodiments, a method for ascertaining a refuel savings for a transportation vehicle firstly comprises a determination of a desired quantity of fuel, i.e., the quantity which is to be refueled or filled. To enable a comparison, possibly between multiple filling stations, at least one first fuel price is ascertained or determined for a first filling station and one second fuel price is ascertained or determined for a second filling station. According to the exemplary embodiments described herein, an additional fuel requirement is furthermore taken into consideration, which is caused by the trip from the present location to the respective positions of the filling station. In this case, according to the exemplary embodiments, both a first additional fuel requirement due to a trip from the present location to a first position of the first filling station and also a second additional fuel requirement due to a trip from the present location to a second position of the second filling station are ascertained. The refuel savings is thereupon ascertained or computed using the desired quantity of fuel, the first fuel price, and the first additional fuel requirement, and also the second fuel price and the second additional fuel requirement.

Because, according to the exemplary embodiments, the additional fuel requirement due to the trip from the present location to the position of the respective filling station is also taken into consideration, the accuracy of the ascertainment of the possible refuel savings is substantially enhanced in comparison to the previously known solutions. In some constellations, this can have the result that the filling station which results in the greatest refuel savings is a different one than in methods in which this additional fuel requirement is not taken into consideration. This can be the case, for example, in a constellation in which the filling station having the most favorable fuel price is substantially farther away from the present position than a filling station which has a somewhat higher fuel price. If the additional fuel requirement due to the trip from the present position to the respective filling station is not taken into consideration, the refuel recommendation could therefore be decidedly for the more remote, more favorable filling station, although the additional fuel requirement is higher than the absolute possible refuel savings upon use of the somewhat more expensive, but substantially closer filling station.

According to some exemplary embodiments, the refuel savings is ascertained in that first refueling costs for the first filling station are determined using the desired quantity of fuel and the first fuel price and the additional fuel requirement, and also second refueling costs are determined using the desired quantity of fuel, the second fuel price, and the second additional fuel requirement. This can enable a user, for example, to take into consideration not only the absolute refuel savings in his or her decision, but rather additionally how much the refuel savings makes up in relation to the absolute refueling costs. This can substantially simplify the decision-making, for example, if the refuel savings is a minimal fraction of the first or second refueling costs required in any case.

According to some exemplary embodiments, the determination of the desired quantity of fuel comprises a determination of a difference between the maximum storage capacity of a fuel reservoir and a quantity of fuel located in the fuel reservoir. That is to say, according to some exemplary embodiments, the maximum possible, presently fillable quantity of fuel is ascertained, based on which the refuel savings is then determined. This can enable the maximum possible refuel savings to be achieved, since it is computed based on the maximum additionally receivable quantity of additional fuel.

According to some exemplary embodiments, the determination of the desired quantity of fuel comprises a user input or a readout from a memory. This can enable the determination of the refuel savings to be designed more flexibly, since the user additionally has the option of individually establishing the desired quantity, whether by way of a stored configuration which was previously performed one time or an acute user input adapted to the respective present circumstances.

According to some exemplary embodiments, the first filling station and the second filling station, for each of which the fuel prices are ascertained, are determined based on the present location and at least one search criterion. That is to say, the filling stations which are considered at all as possible filling stations can be determined based on a search criterion. This enables a user, for example, to monitor the procedure even more accurately, by defining a predetermined radius and his or her present position, for example, within which the filling stations are taken into consideration. For example, on the basis of a further search criterion, it can also be determined according to some exemplary embodiments which brands of the filling stations are to be taken into consideration or not in the ascertainment of the refuel savings. This can be of interest, for example, if the user of the method or a device corresponding thereto has refueling cards at the corresponding filling stations.

According to some exemplary embodiments, the refuel savings is output on a display device, which enables the user to register the refuel savings directly and to make the refueling decision rapidly and intuitively. A display device, on which the refuel savings is displayed, can be a display screen, for example, which is permanently installed inside the transportation vehicle, for example, the display screen of an infotainment system or a display in the cockpit of the transportation vehicle. According to some further exemplary embodiments, in which the method is carried out by a program code on a mobile telephone, the display device is a display screen of the mobile telephone or a mobile terminal. This can enable the driver to already determine the refueling decision or the possible refuel savings when he or she is not yet located in his or her transportation vehicle, which can be accompanied by a time savings after entering the transportation vehicle, on the one hand, and can additionally also reduce a loss of attentiveness in road traffic, if the refueling decision is made in the transportation vehicle.

According to some of these exemplary embodiments, a quantity of the quantity of fuel located in the fuel reservoir is received by the mobile telephone via a wireless data interface from the transportation vehicle, to enable it to use the maximum quantity of fuel to be refueled as the basis of the calculation of the possible refuel savings. Although the method is thus not carried out on a device permanently connected to the transportation vehicle, it can thus be enabled by these exemplary embodiments that the maximum refuel savings can also be ascertained outside the transportation vehicle. The wireless interface is, for example, a short-range radio connection, for example, BLUETOOTH®, ZIBGEE®, or the like. Alternative exemplary embodiments can use, for example, a WLAN connection between the mobile telephone and the transportation vehicle or a mobile data connection, for example, an HSDPA or an LTE connection, to receive the quantity of the quantity of fuel presently located in the fuel reservoir from the transportation vehicle.

According to some further exemplary embodiments, not only the refuel savings, but rather additionally the information about the first refueling costs at the first filling station and about the second refueling costs at the second filling station are displayed on a display device. Furthermore, according to some exemplary embodiments, in addition the first fuel price for the first filling station and the second fuel price for the second filling station are displayed, which can enable the driver to make the decision even more rapidly. In addition to the display of the refuel savings, according to some further exemplary embodiments, a difference between respectively the first fuel price of the first filling station and the second fuel price of the second filling station and the more expensive of the two fuel prices is displayed. That is to say, the difference between the most expensive fuel price and the fuel price of the presently observed filling station is shown in absolute values, which can facilitate the decision for a filling station to be selected.

According to some exemplary embodiments, both the refueling costs and also the refuel savings are displayed in absolute numbers, that is to say, in particular, in a currency unit to be specified by a user of the system or the method or a predefined currency unit as a total amount, i.e., as a dimension which is not scaled to a quantity unit. This specification of absolute numbers enables the user to select the most favorable filling station having the highest refuel savings rapidly without further considerations or computations and thus always make the optimum decision.

In the determination of the refuel savings, the possible refuel savings results from a difference of the absolute refueling costs upon use of the first filling station and the absolute refueling costs upon use of the second filling station. To determine the actual quantity of gasoline to be refueled for each filling station, the desired quantity of fuel is added to the additional fuel requirement which arises due to the trip from the present location to the relevant filling station, to obtain an objective result. Based on this actual fuel requirement per filling station (desired quantity of fuel plus additional fuel requirement), the absolute refueling costs can be determined for each filling station. These absolute refueling costs can be subtracted from one another in pairs, wherein the greatest occurring difference represents the refuel savings in relation to the most expensive filling station. According to some exemplary embodiments, this is displayed to the user as the refuel savings per refueling stop.

In general, a refueling stop can be understood as a procedure in which a refueling procedure is carried out at a fuel source, for example, a filling station for gasoline or diesel, in which the desired quantity of fuel is supplied to a transportation vehicle proceeding from the determination of the possible refuel savings. According to some exemplary embodiments, this can be the maximum storage capacity (maximum tank contents or maximum capacity of a battery) of the fuel reservoir.

In this case, the quantity of fuel to be refueled, on which the determination of the refueling costs for the relevant filling station is based, can be understood, for example, as the difference of maximum storage capacity of the fuel reservoir and the fuel quantity still present in the fuel reservoir upon reaching the selected filling station and/or at the time of the determination of the savings.

In other words, for example, the highest fuel price, which has been ascertained or can be ascertained within the respective required type of fuel and within a determined vicinity from the present transportation vehicle position, can be understood as the fuel price “max”. The fuel price “selection” can be understood as the most favorable fuel price which has been ascertained or can be ascertained within the respective type and within a determined vicinity in relation to the present transportation vehicle position, and/or the fuel price of a selected or preselected filling station. Such a selection can take place, for example, via a menu selection or a map selection. Further presets or search criteria which are used to determine the possible filling stations can be, for example, the distance from the present location to the filling station, the brand, the operator, or the sales chain of the filling station, or also additional services offered by the filling station, such as restaurant, carwash, motel, freeway connection, or the like.

According to the exemplary embodiments, it is also incorporated which additional route including an additional fuel requirement occurring in this case is possibly required for this route to reach the respective filling station participating in the comparison. In this case, the additional route can also be computed, for example, from the closest filling station and/or from a less favorable filling station and/or the most expensive filling station in a predefined vicinity.

The method for ascertaining a refuel savings for a transportation vehicle comprises a determination 110 of a desired quantity of fuel. The method furthermore comprises a determination 120 of a first fuel price of a first filling station and a second fuel price of a second filling station. Furthermore, the method comprises a determination 130 of a first additional fuel requirement due to a trip from a present location to a first position of the first filling station and a second additional fuel requirement due to a trip from the present location to a second position of the second filling station. The determination 140 of the refuel savings takes place using the desired quantity of fuel, the first fuel price, and the first additional fuel requirement, and also the second fuel price and the second additional fuel requirement.

FIG. 2 schematically shows an exemplary embodiment of a device 200 for ascertaining a refuel savings for a transportation vehicle. The device comprises a specification module 210, which is designed to determine the desired quantity of fuel. A data collection module 220 is designed to determine a first fuel price of a first filling station and a second fuel price of a second filling station. A consumption ascertainment module 230 is designed to ascertain a first additional fuel requirement due to a trip from a present location to a first position of the first filling station and a second additional fuel requirement due to a trip from the present location to a second position of the second filling station. An analysis module 240 is designed to determine the refuel savings in a desired currency using the desired quantity of fuel of the first fuel price and the first additional fuel requirement and also the second fuel price and the second additional fuel requirement.

According to some exemplary embodiments, the consumption ascertainment module 230 is designed to determine the desired quantity of fuel from a difference between a maximum storage capacity of a fuel reservoir of the transportation vehicle and a quantity of fuel located in the fuel reservoir. This can take place, for example, using a fill level sensor to register a fill level of a fuel container of the transportation vehicle. Such a fill level sensor can be formed, for example, by one or more floats in a fuel tank for liquid fuel. In the case of electrical energy reservoirs, the fill level sensor can be formed, for example, by a voltage and/or current meter, which determines by suitable analysis logic which voltage or which current applied at a load corresponds to which energy content of the energy reservoir. The determination of the present location can take place by a locating device. Such a locating device can be, for example, a system which analyzes the information of a satellite navigation system (for example, GSP, GLONASS, or Beidou). Other possibilities for position determination are, inter alia, triangulation using items of mobile wireless information or the use of inertial sensors, for example, in conjunction with items of wheel speed and/or steering angle information.

The data collection module can comprise communication methods or mechanisms or control communication methods or mechanisms, for example, which are configured to receive the fuel prices of the filling stations coming into consideration from a network, for example, the Internet. Such communication methods or mechanisms can be, for example, mobile telecommunication terminals, which are based on one or more of the standards GSM, LTE, HDSPA. The data collection module can, of course, make use of any other type of communication, for example, also can ascertain the desired items of information by vehicle-to-vehicle networks directly from a data storage unit in the Internet or on a server located in a network or also directly from another transportation vehicle.

Multiple central computers can be provided for this purpose in the Internet, for example, on which the items of information on fuel prices for the different identified filling stations or fuel supply points are stored. According to some exemplary embodiments, the device 200 comprises a wireless data interface 250, which is designed to receive a quantity of the quantity of fuel located in the fuel reservoir from the transportation vehicle. This can be used for the purpose of enabling a device which is not permanently and fixedly connected to the transportation vehicle, and can nonetheless execute the method described herein. For example, this can be carried out by program code running on a mobile wireless device.

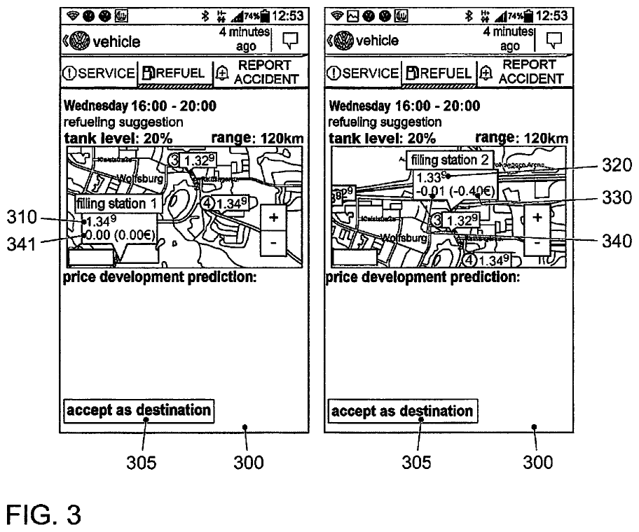

FIG. 3 shows an example of a display device 300, by which the ascertained refuel savings can be displayed together with further optional formations to give a user the option, for example, by a selection field 305, of accepting the recommended filling station, which was ascertained as favorable, as the navigation destination.

Although the display of the possible refuel savings can take place in any arbitrary manner, according to the exemplary embodiment shown in FIG. 3, the filling stations taken into consideration in the ascertainment of the refuel savings are displayed within a map by the display device 300 shown therein. In addition to the ascertained refuel savings 330, to better inform the user of the method or the device corresponding thereto, furthermore the first fuel price 310 of the first filling station and the second fuel price 320 of the second filling station are specified in absolute numbers. In addition, a difference 340, 341 of the first fuel price 310 or the second fuel price 320, respectively, from the most expensive of the considered fuel prices is displayed. In the specific example shown in FIG. 3, this has the result that for the more expensive of the two filling stations, which has the first fuel price 310, a difference 341 of zero is indicated, while in contrast the second fuel price 320 is one cent below the first fuel price 310, and therefore a price delta of one cent is shown as the displayed difference 340.

According to the user interface shown in FIG. 3, the respective recommended or displayed filling station having the refuel savings corresponding thereto can be accepted directly as the destination for a transportation vehicle navigation, by pressing a selection field 305, while the filling station selected by the user is emphasized or displayed. The destination acceptance can additionally also take place in any arbitrary other manner, of course. The subsequent navigation can be carried out, for example, by a navigation device fixedly installed in the transportation vehicle or by a mobile wireless device, on which program code runs, which causes a secure described method to be carried out and the display of the results of the method shown in FIG. 3.

Some exemplary embodiments are thus a mobile telephone having program code which causes one of the methods described herein to be carried out on a mobile telephone.

Although only two filling stations or fuel supply points were discussed in the preceding explanations, to concentrate on the fundamental concept of the exemplary embodiments, it is readily apparent that according to further exemplary embodiments, multiple or an arbitrary number of filling stations can be taken into consideration in the ascertainment of the refuel savings.

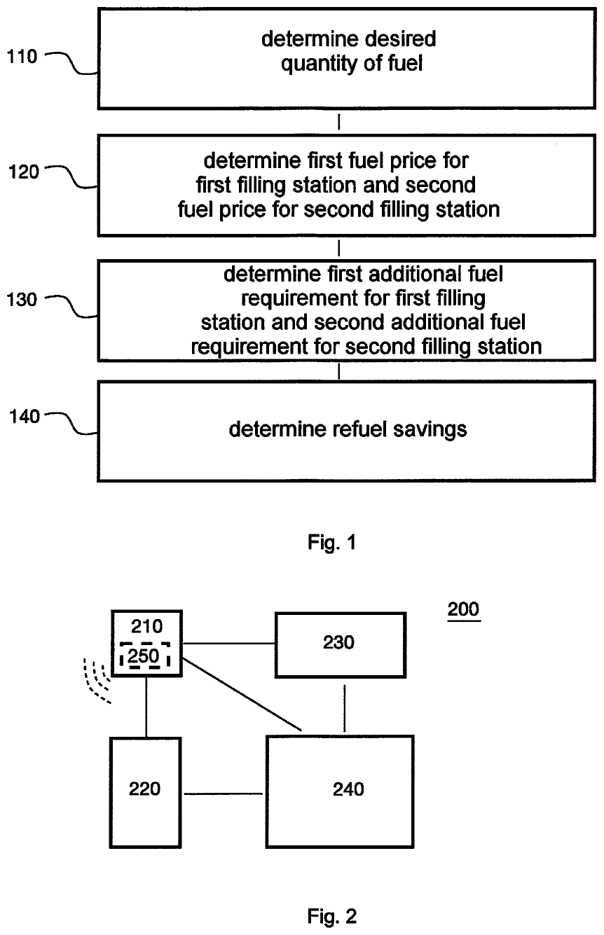

In summary, FIG. 3 schematically shows a display of a device or a method for ascertaining a refuel savings. In the context of the app, in a determined and appropriate radius around the present transportation vehicle position, a search is made for available filling stations. The respective present refuel prices (fuel prices) are ascertained and displayed for the filling stations. Only the relevant prices of the fuel used (diesel or gasoline, etc.) are displayed in this case. In addition, the difference from the price per liter of the most expensive filling station is displayed. Based on the fuel quantity to be refueled, which is ascertained/estimated on the basis of the present tank level, moreover the actual cost savings is indicated in comparison to the most expensive filling station. The most expensive filling station is in this example the one selected in FIG. 1a (price per liter: €1.34). The difference from the most expensive filling station is accordingly €0.00. In the case of the filling station selected in FIG. 1b (price per liter: €1.33), the difference is €0.01 as displayed. A cost savings of €0.40 results therefrom in this example with a tank fill level of 20% and a quantity to be refueled of 40 1 (not shown).

### LIST OF REFERENCE NUMERALS

110 determining a desired quantity of fuel
120 determining a first fuel price of a first filling station and a second fuel price of a second filling station
130 determining a first additional fuel requirement and a second additional fuel requirement
140 determining the refuel savings
200 device for ascertaining a refuel savings
210 specification module
220 data collection module
230 consumption ascertainment module
240 analysis module
250 wireless data interface
300 display device
305 selection field
310 first fuel price
320 second fuel price
330 refuel savings
340 price difference
341 price difference

1. A method for ascertaining a refuel savings for a transportation vehicle, the method comprising:
determining a desired quantity of fuel;
determining a first fuel price of a first filling station and a second fuel price of a second filling station;
determining a first additional fuel requirement due to a trip from a present location to a first position of the first filling station and a second additional fuel requirement due to a trip from the present location to a second position of the second filling station; and
determining the refuel savings using the desired quantity of fuel, the first fuel price and the first additional fuel requirement, and also the second fuel price and the second additional fuel requirement.

2. The method of claim 1, further comprising:
determining first refueling costs using the desired quantity of fuel, the first fuel price, and the first additional fuel requirement, and second refueling costs using the desired quantity of fuel, the second fuel price, and the second additional fuel requirement.

3. The method of claim 1, wherein the determination of the desired quantity of fuel comprises a determination of a difference between a maximum storage capacity of a fuel reservoir and a quantity of fuel located in the fuel reservoir.

4. The method of claim 1, wherein the determination of the desired quantity of fuel comprises receipt of a user input or a readout from a memory.

5. The method of claim 1, further comprising:
determination of the first filling station and the second filling station, based on the present location and at least one search criterion.

6. The method of claim 1, further comprising:
displaying the refuel savings on a display device.

7. The method of claim 6, further comprising:
additionally displaying first refueling costs for the first filling station and second refueling costs for the second filling station.

8. The method of claim 6, further comprising:
additionally displaying the first fuel price for the first filling station and the second fuel price for the second filling station.

9. The method of claim 6, further comprising:
additionally displaying a difference between respectively the first fuel price of the first filling station and the second fuel price of the second filling station and the more expensive of the two fuel prices.

10. A device for ascertaining a refuel savings for a transportation vehicle, the device comprising:
a specification module to determine a desired quantity of fuel;
a data collection module to determine a first fuel price of a first filling station and a second fuel price of a second filling station;
a consumption ascertainment module to ascertain a first additional fuel requirement due to a trip from a present location to a first position of the first filling station and a second additional fuel requirement due to a trip from the present location to a second position of the second filling station; and
an analysis module to determine the refuel savings in a desired currency using the desired quantity of fuel, the first fuel price, and the first additional fuel requirement, and the second fuel price and the second additional fuel requirement.

11. The device of claim 10, wherein the consumption ascertainment module determines the desired quantity of fuel from a difference between a maximum storage capacity of a fuel reservoir and a quantity of fuel located in the fuel reservoir.

12. The device of 10, further comprising:
a wireless data interface to receive a quantity of the quantity of fuel located in the fuel reservoir from the transportation vehicle.

13. A computer program product comprising program code which causes a method for ascertaining a refuel savings for a transportation vehicle to be carried out when the computer program is executed on a programmable hardware component, the method comprising determining a desired quantity of fuel, determining a first fuel price of a first filling station and a second fuel price of a second filling station, determining a first additional fuel requirement due to a trip from a present location to a first position of the first filling station and a second additional fuel requirement due to a trip from the present location to a second position of the second filling station, and determining the refuel savings using the desired quantity of fuel, the first fuel price and the first additional fuel requirement, and also the second fuel price and the second additional fuel requirement.

14. A mobile telephone comprising program code which causes a method for ascertaining a refuel savings for a transportation vehicle to be carried out on the mobile telephone, the method comprising determining a desired quantity of fuel, determining a first fuel price of a first filling station and a second fuel price of a second filling station, determining a first additional fuel requirement due to a trip from a present location to a first position of the first filling station and a second additional fuel requirement due to a trip from the present location to a second position of the second filling station, and determining the refuel savings using the desired quantity of fuel, the first fuel price and the first additional fuel requirement, and also the second fuel price and the second additional fuel requirement.

15. The computer program product of claim 13, wherein the method further comprises determining first refueling costs using the desired quantity of fuel, the first fuel price, and the first additional fuel requirement, and second refueling costs using the desired quantity of fuel, the second fuel price, and the second additional fuel requirement.

16. The computer program product of claim 13, wherein the determination of the desired quantity of fuel comprises a determination of a difference between a maximum storage capacity of a fuel reservoir and a quantity of fuel located in the fuel reservoir, receipt of a user input or a readout from a memory.

17. The computer program product of claim 13, further comprising determination of the first filling station and the second filling station, based on the present location and at least one search criterion.

18. The computer program product of claim 13, further comprising displaying the refuel savings on a display device and additionally displaying one of a first refueling costs for the first filling station and second refueling costs for the second filling station, the first fuel price for the first filling station and the second fuel price for the second filling station, and a difference between respectively the first fuel price of the first filling station and the second fuel price of the second filling station and the more expensive of the two fuel prices.

19. The mobile telephone of claim 14, wherein the method further comprises determining first refueling costs using the desired quantity of fuel, the first fuel price, and the first additional fuel requirement, and second refueling costs using the desired quantity of fuel, the second fuel price, and the second additional fuel requirement.

20. The mobile telephone of claim 14, wherein the determination of the desired quantity of fuel comprises a determination of a difference between a maximum storage capacity of a fuel reservoir and a quantity of fuel located in the fuel reservoir, receipt of a user input or a readout from a memory.

21. The mobile telephone of claim 14, further comprising determination of the first filling station and the second filling station, based on the present location and at least one search criterion.

22. The mobile telephone of claim 14, further comprising displaying the refuel savings on a display device and additionally displaying one of a first refueling costs for the first filling station and second refueling costs for the second filling station, the first fuel price for the first filling station and the second fuel price for the second filling station, and a difference between respectively the first fuel price of the first filling station and the second fuel price of the second filling station and the more expensive of the two fuel prices.
